(19) United States
(12) Patent Application Publication
(10) Pub. No.: US 2009/0073915 A1
(43) Pub. Date: Mar. 19, 2009

(54) APPARATUS, SYSTEM AND METHOD FOR IMPLEMENTING MOBILE COMMUNICATION

(75) Inventors: Aimin ZHANG, Shenzhen (CN); Jiang LI, Shenzhen (CN); Shiqiang DENG, Shenzhen (CN)

Correspondence Address: Leydig, Voit & Mayer, Ltd;(for Huawei Technologies Co., Ltd), Two Prudential Plaza Suite 4900, 180 North Stetson Avenue, Chicago, IL, 60601, US

(73) Assignee: HUAWEI TECHNOLOGIES CO., LTD., Shenzhen (CN)

(21) Appl. No.: 12/258,889

(22) Filed: Oct. 27, 2008

Related U.S. Application Data
(63) Continuation of application No. PCT/CN2007/001387, filed on Apr. 25, 2007.

(30) Foreign Application Priority Data
Apr. 28, 2006 (CN) 200610076168.6

(51) Int. Cl. H04W 88/04

(52) U.S. Cl. 370/315

(57) ABSTRACT

An apparatus, system and method for implementing mobile communication are described. The apparatus includes: a transmitter, a receiver, a duplexer, and an antenna. The apparatus further includes: an uplink data processing module, configured to process data transmitted from a terminal to a base station and received by the receiver, and transmit the processed data to the transmitter; a downlink data processing module, configured to process data transmitted from a base station to a terminal and received by the receiver, and transmit the processed data to the transmitter, the downlink data processing module sharing the transmitter and the receiver with the uplink data processing module in a time-division manner; and a control processor, configured to control the transmitter, the receiver, the uplink data processing module, and the downlink data processing module.

### CROSS-REFERENCE TO RELATED APPLICATION

This application is a continuation of International Patent Application No. PCT/CN2007/001387, filed Apr. 25, 2007, which claims priority to Chinese Patent Application No. 200610076168.6, filed Apr. 28, 2006, both of which are hereby incorporated by reference in their entirety.

### FIELD OF THE INVENTION

The present invention relates to wireless communication technology, particularly, to an apparatus, system and method for implementing mobile communication.

### BACKGROUND

As the demand for wireless communication is increasing, the Broadband Wireless Access (BWA) technology is gradually becoming one of the focuses in current communication technologies. The Orthogonal Frequency Division Multiplexing Access (OFDMA) scheme is applied by more and more broadband wireless access standards because of its unique advantages. For example, the OFDMA is used as one of the multiplexing access methods in the Worldwide Interoperability for Microwave Access (WiMAX) system, which is based on the IEEE 802.16 protocol.

The air interface of the WiMAX system applies the IEEE 802.16 standard. The structures, defined in the IEEE 802.16 standard, of a base station frame and corresponding terminal frame using the OFDMA under the Time Division Duplex (TDD) mode are shown in FIGS. 1 and 2. FIG. 1 is the structure of a base station frame, and FIG. 2 is the structure of a terminal frame. The base station frame includes a downlink sub-frame for transmitting downlink data and an uplink sub-frame for receiving uplink data. TTG is the time interval for the base station to transit from a transmit status to a receive status, and RTG is the time interval for the base station to transit from a receive status to a transmit status. SSRTG is the time interval for the terminal to transit from a receive status to a transmit status, and SSTTG is the time interval for the terminal to transit from a transmit status to a receive status. Logical sub-channel numbers refer to the logically ordered sub-channel numbers, and one sub-channel includes several sub-carriers. Traffic bursts refer to the traffic data using the same encoding modulation. A frame header includes a preamble and time-frequency resource allocation information. The preamble is configured for time-frequency synchronization between a terminal and a base station, and the time-frequency resource allocation information represents the time-frequency resource location of user data in a downlink sub-frame and an uplink sub-frame, through which the terminal can know from which downlink traffic burst it should receive data and via which uplink traffic burst to transmit its own data. An access sub-channel is configured for a terminal to randomly access a network, and a base station captures an access request from a terminal by monitoring the access sub-channel.

However, in the WiMAX system, because an electromagnetic wave undergoes severe loss due to high frequency transmission, the coverage area of the system is small. Moreover, due to few of users in the early stage of networking, time-frequency resources within the coverage area of the system tend to be not sufficiently used under the condition of low load.

### SUMMARY

The present invention provides an apparatus for implementing mobile communication, for expanding the coverage area of a base station, and reducing the cost in the networking of a system.

Another object of an embodiment of the present invention provides a method for implementing mobile communication, which allows a terminal remote from a base station to access through a relay station near the terminal.

The third object of an embodiment of the present invention provides a system for implementing mobile communication, for forwarding data through a relay station between a base station and a terminal.

In order to achieve the above main object, an embodiment of the present invention provides an apparatus for implementing mobile communication. The apparatus includes a transmitter, a receiver, a duplexer, and an antenna. The duplexer is connected with the antenna and the transmitter and the receiver are connected with the duplexer. The apparatus further includes: an uplink data processing module, configured to process data transmitted from a terminal to a base station and received by the receiver, and transmit the processed data to the transmitter; a downlink data processing module, configured to process data transmitted from a base station to a terminal and received by the receiver, and transmit the processed data to the transmitter, the downlink data processing module sharing the transmitter and the receiver with the uplink data processing module in a time-division manner; and a control processor, configured to control the transmitter, the receiver, the uplink data processing module, and the downlink data processing module.

In order to achieve the object, an embodiment of the present invention further provides a method for implementing mobile communication, comprising deploying a relay station between a base station and a terminal, and setting a base station frame structure and a relay station frame structure. The method includes: enabling relay function by the relay station after accessing a network; and forwarding data by the relay station between the terminal and the base station.

In order to achieve the third object, an embodiment of the present invention further provides a system for implementing mobile communication. The system includes: a terminal, configured to transmit data to a base station through a relay station, and receive data from the base station through the relay station; the relay station, configured to forward data between the terminal and the base station; and the base station, configured to transmit data to the terminal through the relay station, and receive data from the terminal through the relay station.

### BRIEF DESCRIPTION OF THE DRAWING(S)

FIG. 1 is a structure diagram of a base station frame under the time division duplex OFDMA mode in a WiMAX system;

FIG. 2 is a structure diagram of a terminal frame under the time division duplex OFDMA mode in a WiMAX system;

FIG. 3 is a schematic structure diagram of a relay station, according to an embodiment of the present invention;

FIG. 4 is a schematic structure diagram of a binding table maintained by a base station, according to the present invention;

FIG. 5 is a flowchart of enabling relay function by a relay station, according to an embodiment of the present invention;

FIG. 6 is a flowchart of forwarding data by a relay station from a base station to a terminal, according to an embodiment of the present invention;

FIG. 7 is a flowchart of forwarding data by a relay station from a terminal to a base station, according to an embodiment of the present invention;

FIG. 8 is a structure diagram of a base station frame, according to the first embodiment of the present invention;

FIG. 9 is a structure diagram of a relay station frame, according to the first embodiment of the present invention;

FIG. 10 is a structure diagram of a base station frame and a relay station frame, according to the third embodiment of the present invention;

FIG. 11 is a structure diagram of a base station frame and a relay station frame, according to the fifth embodiment of the present invention;

FIG. 12 is a structure diagram of a base station frame and a relay station frame, according to the sixth embodiment of the present invention;

FIG. 13 is a structure diagram of a base station frame, according to the seventh embodiment of the present invention;

FIG. 14 is a structure diagram of a relay station frame, according to the seventh embodiment of the present invention;

FIG. 15 is a structure diagram of a base station frame, according to the eighth embodiment of the present invention;

FIG. 16 is a structure diagram of the relay station frame, according to the eighth embodiment of the present invention;

FIG. 17 is a structure diagram of a base station frame and a relay station frame, according to the ninth embodiment of the present invention; and

FIG. 18 is a structure diagram of a system for implementing mobile communication with relay stations, according to an embodiment of the present invention.

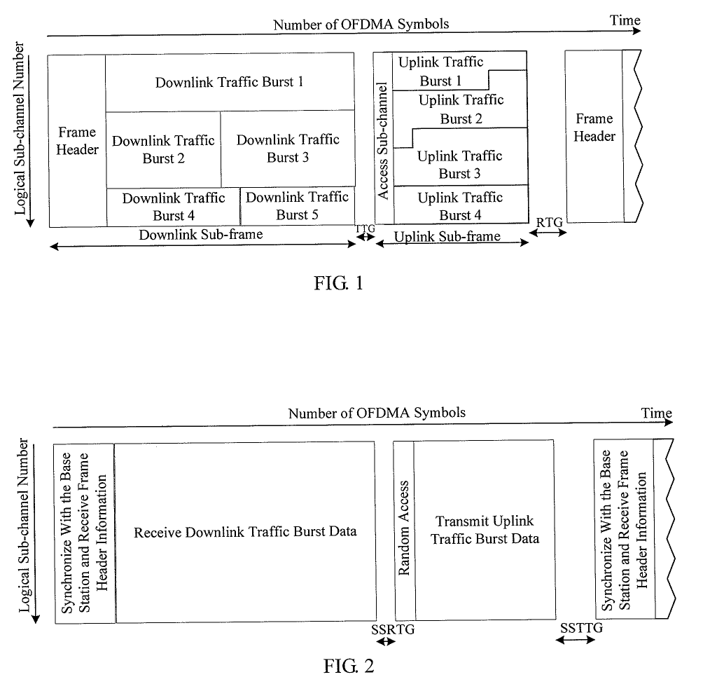

### DETAILED DESCRIPTION

FIG. 3 is a schematic structure diagram of a relay station according to an embodiment of the present invention, in which solid lines represent data flows and dashed lines represent control flows. The apparatus includes a transmitter 3, a receiver 4, a duplexer 2, and an antenna 1. The duplexer 2 is connected with the antenna 1, and the transmitter 3 and the receiver 4 are connected with the duplexer 2. Both the antenna 1 and the duplexer 2 are of conventional types, i.e. conventional antenna and transceiver capable of performing transmitting and receiving functions with the single antenna. The receiver 4 converts a radio frequency signal into a baseband digital signal, and the transmitter 3 converts a baseband digital signal into a radio frequency signal.

Specifically, the apparatus further includes: an uplink data processing module 5, configured to process data transmitted from a terminal and received by the receiver 4, and transmit the processed data to a base station by the transmitter 3; a downlink data processing module 6, configured to process data transmitted from a base station and received by the receiver 4, and transmit the processed data to the terminal by the transmitter 3, in which the downlink data processing module shares the transmitter and the receiver with the uplink data processing module 5 in a time-division manner, and the switching between the uplink data processing module and the downlink data processing module is controlled by a control processor 7; and the control processor 7, configured to control the data interaction among the transmitter 3, the receiver 4, the uplink data processing module 5 and the downlink data processing module 6.

The uplink data processing module 5 further includes: an uplink decoding unit 8, configured to, under the control of the control processor 7, obtain un-encoded original information data through OFDM demodulating, de-symbol mapping, de-interleaving and channel decoding the baseband signal transmitted from the terminal to the base station and received by the receiver 4; an uplink data buffering unit 9, configured to buffer the data transmitted from the terminal to the base station and processed by the uplink decoding unit 8; an uplink quality measuring unit 10, configured to, under the control of the control processor 7, measure the quality of the user uplink signal processed by the uplink decoding unit 8, in which signal quality parameters may be the receive power of uplink signal, signal to noise ratio (SNR), signal to interference and noise ratio (SINR), bit error rate (BER) and packet error rate (PER), and which parameter is to be measured is controlled by the control processor 7; and an uplink encoding unit 11, configured to, under the control of the control processor 7, channel encode, interleave, symbol map and OFDM modulate the original data information in the uplink data buffering unit 9, and transmit the processed data to the transmitter 3.

The downlink data processing module 6 further includes: a downlink decoding unit 12, configured to, under the control of the control processor 7, obtain un-encoded original information data through OFDM demodulating, de-symbol mapping, de-interleaving and channel decoding a baseband signal transmitted from the base station to the terminal and received by the receiver 4; a downlink data buffering unit 14, configured to buffer the data transmitted from the base station to the terminal and processed by the downlink decoding unit 12; a base station command extracting unit 13, configured to extract base station commands from the data processed by the downlink decoding unit 12, and control other units through the control processor 7; and a downlink encoding unit 15, configured to, under the control of the control processor 7, channel encode, interleave, symbol map and OFDM modulate the original information data in the downlink data buffering unit 14, and transmit the processed data to the transmitter 3.

Unlike the conventional relay station that only amplifies and forwards original signals, the relay station according to an embodiment of the present invention may re-decode and re-encode the original signal, and provide services for terminals outside of the coverage area of a base station, thus significantly improving SNR, avoiding positive feedback and overcoming self excitation phenomenon occurred in conventional relay stations.

In an embodiment of the present invention, the link between a base station and a relay station is considered as a virtual connection and the virtual connection is directional. In other words, the connection for uplink and the connection for downlink are different. Each connection may be distinguished by a connection identifier (CID), and different connections have different connection identifiers, in which connection identifiers are centralized assigned by the base station. During the establishment of a connection between the base station and the terminal, the base station informs the terminal the corresponding connection identifier. The base station broadcasts the corresponding relationship between connection identifiers and time-frequency resources in the frame header of a data frame to all terminals within its own coverage area. After acknowledging the corresponding relationship between the connection identifiers and the time-frequency resources, the terminal may extract its own data from a downlink traffic frame of the base station and transmit its own data in an uplink traffic frame.

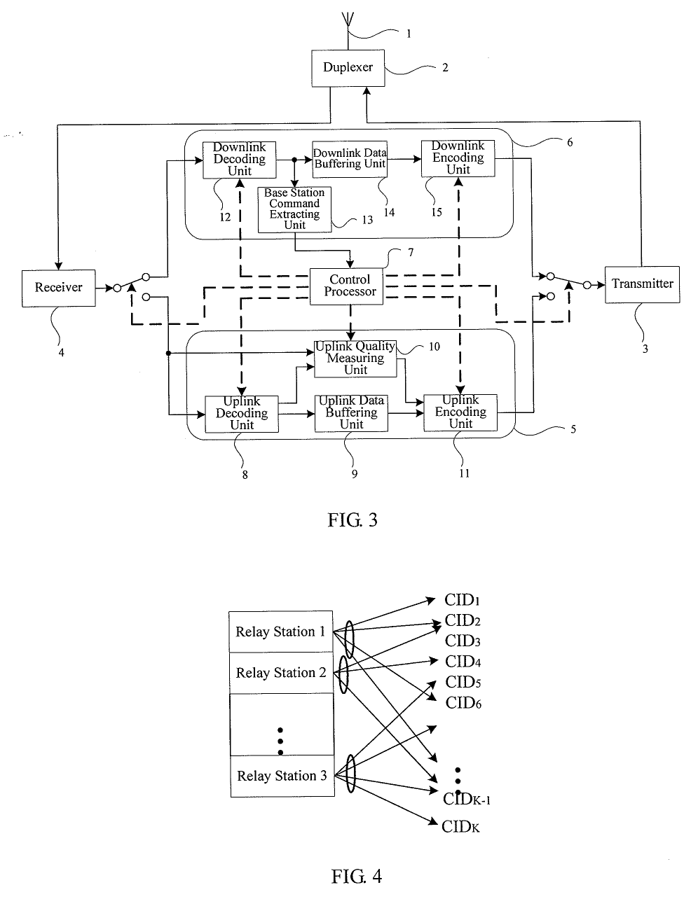

In an embodiment of the present invention, the base station maintains a binding table for relay stations and connection identifiers for uplink and downlink, respectively, and each item of the table is configured to represent connections managed by a corresponding relay station. The structure of the table is shown in FIG. 4, in which CIDN is a connection identifier. One relay station may manage a plurality of connections, and one connection may be managed by a plurality of relay stations. The relay station also maintains a connection identifier table for terminals managed by itself, and corresponding items of the connection identifier table and the connection identifier binding table of the base station are completely consistent. To save unnecessary consumption, each relay station maintains connection identifiers of terminals managed by itself, while does not maintain connection identifiers of terminals managed by other relay stations. When the base station decides to change the connections managed by a certain relay station, such as adding or deleting a connection, the base station would inform the relay station to modify the binding table of the relay station and update the base station's own binding table after obtaining the relay station's confirmation. With the binding table, the relay station knows which data are to be received from the base station and from which terminal to receive data. In the embodiment of the present invention, each item of the connection identifier binding table may also be the corresponding relationship between a relay station and other identifiers of all terminals managed by the relay station, in which other identifiers may be any identifier that uniquely identifies the terminals, such as the MAC addresses of the terminals, etc.

With the relay station according to an embodiment of the present invention, the base station may provide services for terminals outside of its coverage area through the relay station in addition to provide services for terminals within its coverage area. For a base station, a relay station is equivalent to a terminal, and for a terminal, a relay station is equivalent to a base station. There is one base station and a plurality of relay stations in one area, in which the base station and the relay stations may orthogonally multiplex the same time-frequency resources and may also non-orthogonally multiplex the same time-frequency resources, as long as within allowed interference range.

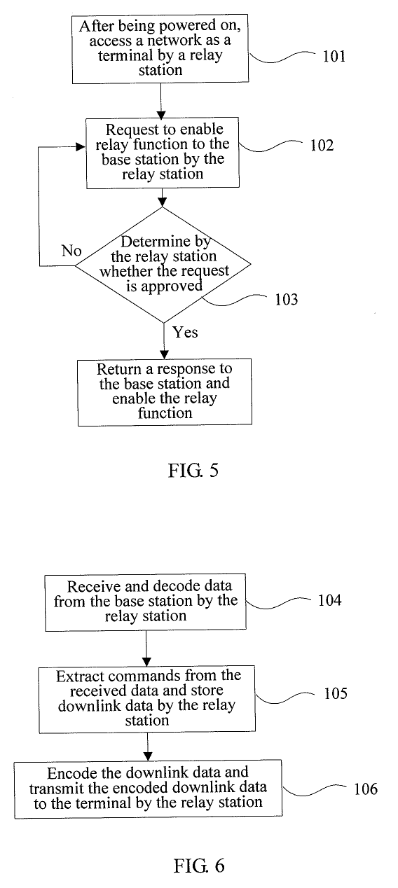

FIGS. 5 to 7 are flowcharts of a method for implementing mobile communication with relay stations according to an embodiment of the present invention. Specifically, the method performs the following steps.

Step 101: After being powered on, a relay station accesses a network as a terminal, and applies the same frame structure as that of a terminal.

Step 102: The relay station transmits a request message for requesting to enable relay function to a base station.

Step 103: The relay station determines whether the request is approved by the base station, and if the request is approved by the base station, returns a response to the base station and enables the relay function, or goes to step 102.

After enabling the relay function, while forwarding data from the base station to the terminal, the relay station performs the following step 104 to step 106:

Step 104: A receiver of the relay station receives data from the base station through a downlink relay sub-frame, and a downlink decoding unit of the relay station decodes the received data to obtain original data which includes control commands transmitted from the base station to the relay station and downlink data transmitted from the base station to the terminals through the relay station.

Step 105: A base station command extracting unit of the relay station extracts the commands from the received data, and a downlink data buffering unit of the relay station stores the downlink data.

Step 106: A downlink encoding unit of the relay station encodes the downlink data and transmits the encoded downlink data to the terminal through a transmitter of the relay station.

While forwarding data from the terminal to the base station, the relay station performs the following step 107 to step 109:

Step 107: The receiver of the relay station receives data from the terminal through an uplink terminal sub-frame, and an uplink decoding unit of the relay station decodes the received data to obtain original data which includes uplink data transmitted from the terminal to the base station.

Step 108: An uplink data buffering unit of the relay station stores the uplink data.

Step 109: An uplink encoding unit of the relay station encodes the uplink data, and transmits the encoded uplink data to the base station in an uplink relay sub-frame through the transmitter.

Steps 101 to 103 are steps for enabling the relay station, Steps 104 to 106 are steps for the relay station to forward data from the base station to the terminal, and Steps 107 to 109 are steps for the relay station to forward data from the terminal to the base station.

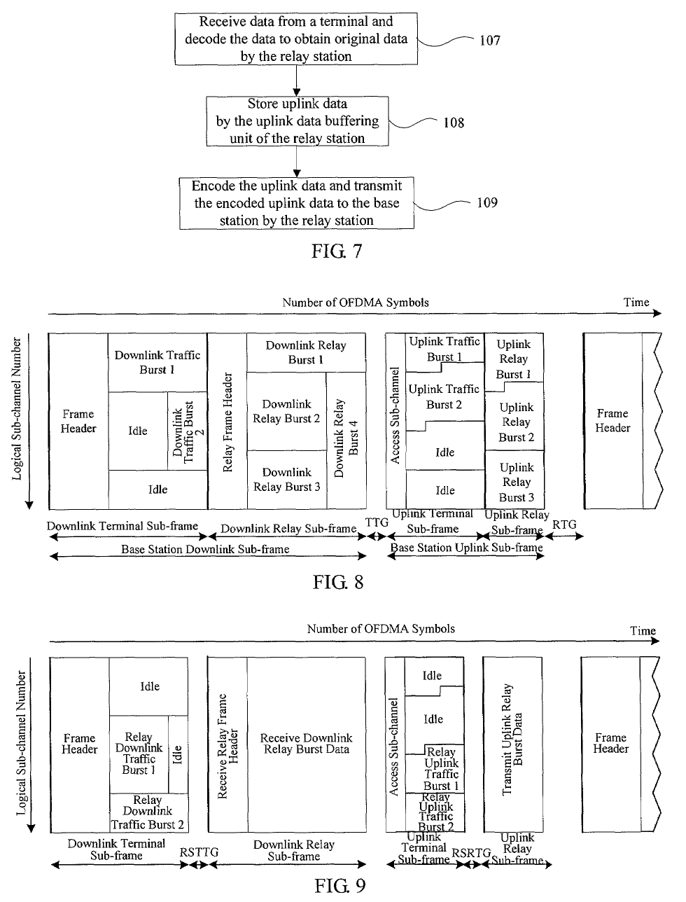

During the above procedure, after the relay station enables the relay function, the applied frame structure is switched from a conventional terminal frame structure to the relay station frame structure shown in FIG. 7. Then, the relay station may acquire time-frequency resource allocation information for downlink relay sub-frame and uplink relay sub-frame from a relay frame header. In the next frame, the relay station may construct and transmit a frame header, according to information received from the base station in the last downlink relay sub-frame, and receive data from the terminal in an uplink terminal sub-frame, including receiving terminal's access request from an access sub-channel. In addition, the relay station may not transmit the frame header so as to reduce the complexity of the relay station.

Due to the relay station according to an embodiment of the present invention, the current base station frame structure needs to be modified and a relay station frame structure needs to be defined. Specific base station frame structure and relay station frame structure may be of different constructions, which are described in detail below with reference to embodiments and drawings.

According to the apparatus and method provided in embodiments of the present invention, through introducing a relay station into the wireless communication system, modifying base station frame structure in the current protocol and designing a relay sub-frame structure, communication rate of terminals within the coverage area of a base station is improved, and terminals outside of the coverage area of the base station may also be provided with services, thus greatly expanding the coverage area of the base station, reducing the number of base stations in early stage of networking and improving spectrum utilization. In addition, for a terminal near a relay station but remote from a base station, transmission through a relay station may decrease the transmit and receive power of the terminal, thus saving battery consumption and effectively extending the life time of the terminal's battery.

In one embodiment of present invention, the basic base station frame structure according to an embodiment of the present invention is shown in FIG. 8, and the relay station frame structure is shown in FIG. 9. RSTTG represents the time for the relay station to transit from a transmit status to a receive status, and RSRTG represents the time for the relay station to transit from a receive status to a transmit status. The base station frame includes a base station uplink sub-frame and a base station downlink sub-frame. The base station downlink sub-frame is further divided into two sections, one section is known as a downlink terminal sub-frame, which is configured for the base station to provide services for terminals within its coverage area, and the other section is known as a downlink relay sub-frame, which is configured to provide services for the relay station. Similarly, the base station uplink sub-frame is also divided into two sections, in which one section is known as an uplink terminal sub-frame which is configured to provide services for terminals within the base station's coverage area, and the other section is known as an uplink relay sub-frame which is configured to provide services for the relay station. Since, in the configuration information of a frame header, no time-frequency resources of downlink relay sub-frame and uplink relay sub-frame will be allocated for any terminal, a terminal always considers there is no data that belongs to itself in these two sections, that is, the downlink relay sub-frame and the uplink relay sub-frame are completely transparent for the terminal. Generally, frame lengths of the base station downlink sub-frame and the base station uplink sub-frame are relatively fixed, i.e. once these two parameters are set, they will not be changed during the base station's operation. In the embodiments of the present invention, in case that the frame lengths of the base station downlink sub-frame and the base station uplink sub-frame remain unchanged, dynamic adjustment may be made according to traffic conditions to the frame lengths of the downlink terminal sub-frame and the downlink relay sub-frame, the frame lengths of the uplink terminal sub-frame and the uplink relay sub-frame, and the sub-channel resources occupied by the uplink relay sub-frame and the downlink relay sub-frame, thus allowing more flexible configuration and utilization of time-frequency resources. The allocation of downlink traffic bursts and uplink traffic bursts of the base station and downlink traffic bursts and uplink traffic bursts of the relay station are completely consistent with the prior art. The downlink traffic bursts and uplink traffic bursts of the relay station are all allocated by the base station and informed the relay station through downlink relay burst data; however, the delay station can not allocate time-frequency resources of the traffic bursts by itself.

The downlink relay sub-frame of the base station frame structure includes a relay frame header and downlink relay burst data. The relay frame header is the time-frequency resource allocation information for uplink and downlink relay sub-frames, according to which the relay station receives downlink relay burst data and transmits uplink relay burst data, which is similar with that of the conventional base station frame. The downlink relay burst data may be broadcast information transmitted from the base station to all relay stations, and may also be traffic data transmitted to a certain relay station. The broadcast information includes frame header information of the next frame, according to which the relay station may reconstruct the frame header of the next frame and ensure the frame header is consistent with the frame header of the base station. According to the frame header information of the next frame, the relay station may know the allocation conditions for traffic bursts of the downlink terminal sub-frame and uplink terminal sub-frame. Accordingly, the relay station may know, according to its connection identifier binding table, to which terminal it should forward data in a downlink terminal sub-frame and from which terminal it should receive data in an uplink terminal sub-frame.

In correspondence to the base station frame structure, the downlink terminal sub-frame in a relay station frame structure is configured to forward downlink data from the base station to the terminal so as to provide services for terminals outside of the coverage area of the base station, in which the data is extracted by the relay station from its downlink data buffer. Because a terminal performs original synchronization and acquires time-frequency resource allocation information from a frame header, the information transmitted in a relay station frame header is the same with what is transmitted in the base station frame header so that all terminals in the cell can be properly synchronized and receive the same time-frequency resource allocation information. If frame headers of the base station frame and the relay station frame are not consistent, cells located in both the coverage area of the base station and the coverage area of the relay station would be interfered. In addition, the time-frequency resource used in the relay downlink sub-frame is orthogonal to the corresponding portion of the base station. The terminal receives data that belongs to itself according to the information obtained from the frame header and is not aware of the existence of the relay station at all.

The relay station receives data from the base station in the downlink relay sub-frame, which includes control commands transmitted from the base station to the relay station and downlink data that the base station requires the relay station to forward to the terminal. The base station command extracting unit of the relay station extracts the commands from the received data, and the downlink data buffering unit stores data that is to be forwarded to the terminal in the downlink data buffer. The relay station forwards, in the uplink relay sub-frame, all data received from the terminal to the base station, in which the data is extracted from the uplink data buffer of the relay station. In addition, some control information transmitted from the relay station to the base station may also be transmitted in the uplink relay sub-frame.

In a transmitted physical frame, each burst should transmit a pilot for channel estimation of the receive side. For a downlink terminal channel, because data may be either transmitted from the base station or transmitted from the relay station, the transmission of the pilot should be limited in each traffic burst. For example, in FIG. 8, the pilot for estimating the channel corresponding to the time-frequency resource of downlink traffic burst 1 can only be transmitted by the base station rather than the relay station; similarly, the pilot for estimating the channel corresponding to the time-frequency resource of relay downlink traffic burst 1 can only be transmitted by the relay station rather than the base station. Similar cases occur to an uplink relay sub-frame which may be transmitted by different relay stations. Assuming that the uplink relay burst 1 is transmitted by the relay station 1, the pilot for estimating the channel corresponding to the time-frequency resource of this burst can only be transmitted by the relay station 1 rather than other relay stations.

In another embodiment of present invention, in FIG. 8, the time order of uplink terminal sub-frame and uplink relay sub-frame in the base station uplink sub-frame may be interchanged. After interchanging, during the period of one frame, the relay station needs to perform the switching between a transmit status and a receive status for four times; however, according to the scheme in FIG. 8, the relay station only needs to perform the switching for two times.

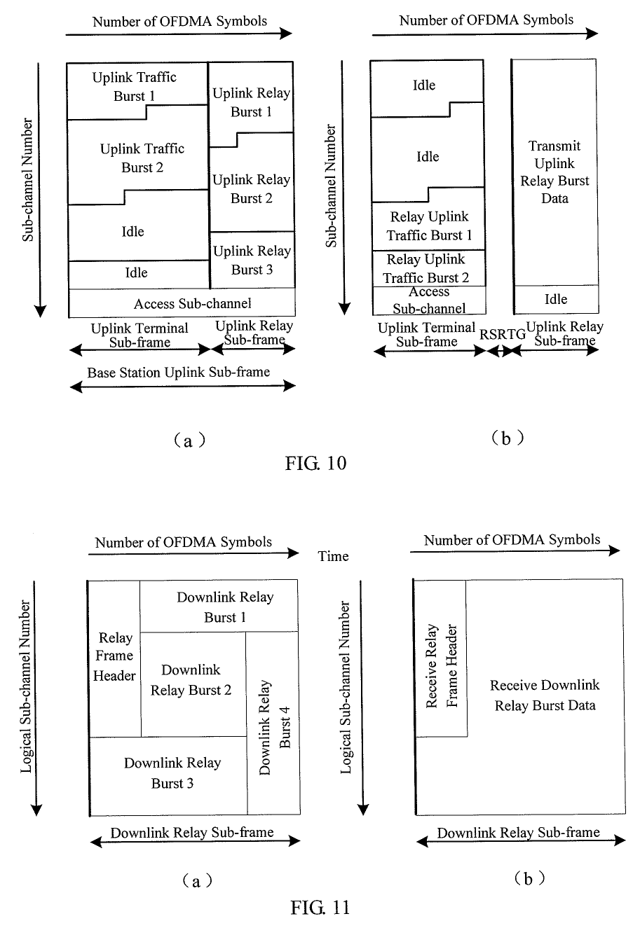

In another embodiment of present invention, in addition to the manners shown in FIGS. 8 and 9, the manner shown in FIG. 10 may also be adopted by the access sub-channel, in which (a) is a base station frame and (b) is a relay station frame. Similarly, the access sub-channel may also locate at other positions.

In another embodiment of present invention, in the base station frame shown in FIG. 8, the relay frame header may also include a training sequence especially for the synchronization between the relay station and the base station, so that a better synchronization between the relay station and the base station could be achieved.

In another embodiment of present invention, the frame header of the downlink relay sub-frame may not occupy the entire OFDMA symbol, but a portion of the OFDMA symbol, as shown in FIG. 11, in which (a) is a base station frame and (b) is a relay station frame.

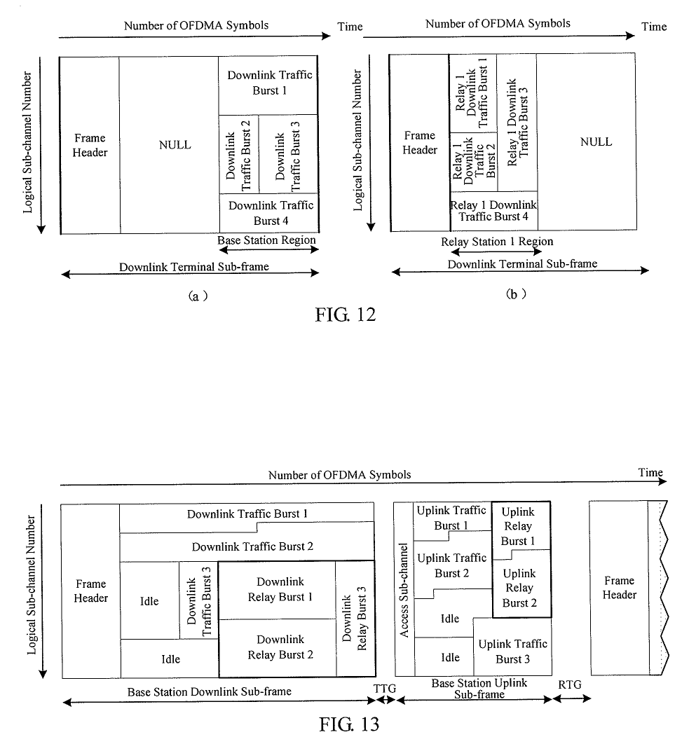

In another embodiment of present invention, traffic bursts in the downlink terminal sub-frame may be arranged as shown in FIG. 12, in which (a) is a base station frame and (b) is a relay station frame. That is, for a transmit side, its time-frequency resources are allocated in terms of the time. For example, the base station can only transmit in the area of the base station, and the relay station 1 can only transmit in the area of the relay station 1. FIG. 11 shows the case that there is only one relay station, and it is similar to the case that there is a plurality of relay stations. Only the case of downlink terminal sub-frame is described here, and it is similar to the case of uplink terminal sub-frame the description of which is thus omitted.

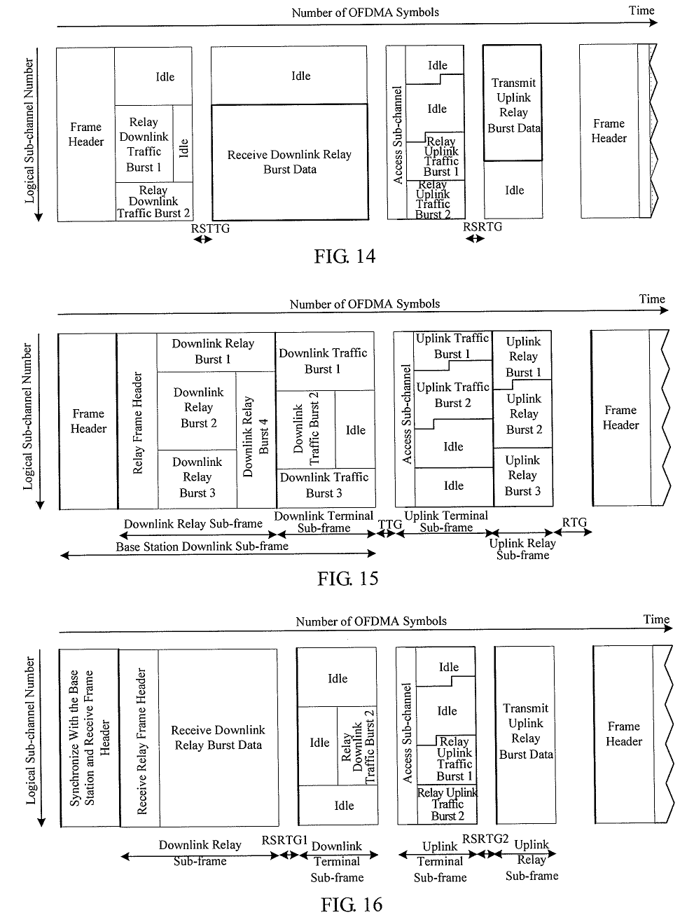

In another embodiment of present invention, in addition to the schemes of frame structure shown in FIGS. 8 and 9, the schemes shown in FIGS. 13 and 14 may also be adopted, in which FIG. 13 shows a base station frame and FIG. 14 shows a relay station frame. In this embodiment, the downlink data transmitted from the base station to the relay station occupies part of time-frequency resources of the base station downlink sub-frame. At this time, the time-frequency resource for the downlink transmitted from a base station or relay station to a terminal is referred to as a downlink terminal region rather than a downlink terminal sub-frame, the time-frequency resource for the downlink transmitted from the base station to the relay station is referred to as a downlink relay region, the time-frequency resource for the uplink transmitted from the terminal to the relay station or the base station is referred to as an uplink terminal region, and the time-frequency resource for the uplink transmitted from the relay station to the base station is referred to as an uplink relay region. There is no relay frame header similar to that of FIG. 8 in the downlink terminal region, and the allocation information of time-frequency resources of traffic bursts in the region is provided by the frame header of the entire frame. The allocation information of time-frequency resources of traffic bursts in the uplink relay region is also provided by the frame header of the entire frame.

In another embodiment of present invention, for the relay station in an embodiment of the present invention, in addition to the above frame structure schemes, the frame structure schemes shown in FIGS. 15 and 16 may also be adopted, in which FIG. 15 shows a base station frame and FIG. 16 shows a relay station frame. In this scheme, the base station transmits frame headers and broadcast information with high power, and the relay station does not transmit. For downlink data to be forwarded to the terminal, the base station firstly transmits the downlink data to the relay station in the downlink relay sub-frame, of which the frame header is used to inform the terminal that time-frequency resources are allocated for it in the downlink terminal sub-frame. The relay station forwards the data to the terminal in the corresponding time-frequency resource of the subsequent downlink terminal sub-frame. It is similar for the forwarding of uplink signal. The first advantage of this frame structure is that it is avoided for the base station to transmit broadcast information of the next frame to the relay station in each frame, so that the consumption of the air interface is saved. The second advantage is that the base station does not need to allocate resources in a previous frame, but can allocate resources with newer channel information, thus adapting to rapidly changing channels.

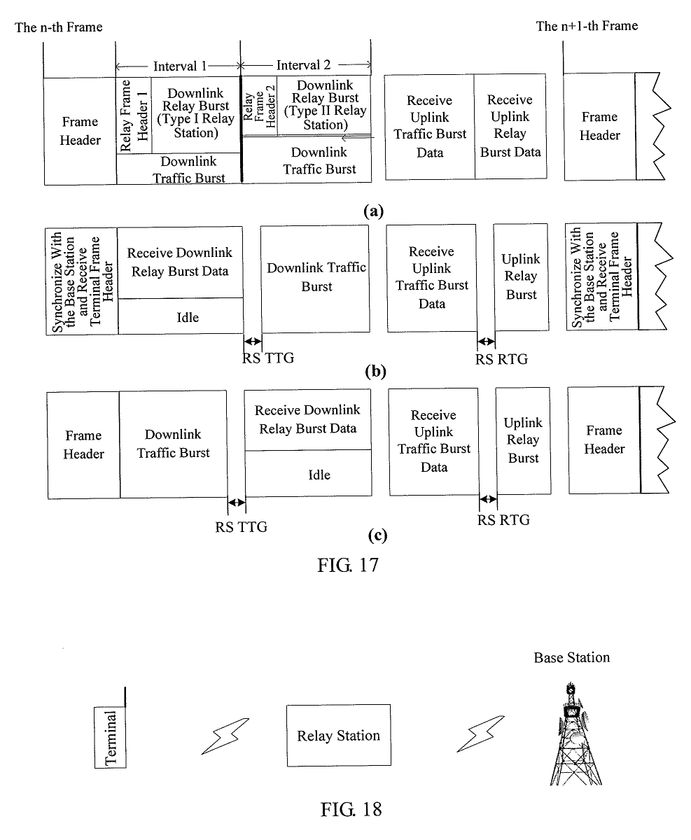

In another embodiment of present invention, it illustrates a generalized frame structure as shown in FIG. 17, in which (a) is a base station frame, (b) is a type I relay station frame and (c) is atype II relay station frame.

The base station downlink sub-frame is temporally divided into two sections (interval 1 and interval 2) for supporting two types of relay stations. The type I relay station does not transmit frame header and thetype II relay station transmits frame header. The boundary between the interval 1 and the interval 2 may be fixed, or may be dynamically variable with the time. However, before each variation, the base station needs to inform the type II relay station that a variation will occur; otherwise, thetype II relay station cannot know from where to receive the relay frame header transmitted to it.

The relay frame header (relay frame header 1 in FIG. 17) and data provided for the type I relay station by the base station are transmitted in the interval 1 of the downlink sub-frame, and the relay frame header (relay frame header 2 in FIG. 17) and data provided for the type II relay station by the base station are transmitted in the interval 2 of the downlink sub-frame. The relay frame header 1 defines the time-frequency resources allocated by the base station for the type I relay station, and the relay frame header 2 defines the time-frequency resource information allocated by the base station for thetype II relay station. The type I relay station transmits downlink data to terminals managed by it in the interval 2, and the type II relay station transmits downlink data to terminals managed by it in the interval 1.

It is not shown in FIG. 17 the relationship of time-frequency resource allocation between downlink traffic bursts of the base station and downlink traffic bursts of the relay station. However, regardless of the type I ortype II relay station, when they transmit downlink traffic bursts to a terminal, orthogonality of time-frequency resources needs to be ensured. If the time-frequency resources are not orthogonal, it should be ensured that the interference between data transmitted from the base station and data transmitted from the relay station is within an allowed range.

FIG. 18 is a structure diagram of a system for implementing mobile communication with relay stations, according to an embodiment of the present invention. In the system, a relay station is deployed between a base station and a terminal, which is used to forward data between the base station and the terminal. The system includes: the terminal, configured to transmit data to the base station through the relay station, and receive data from the base station through the relay station; the relay station, configured to forward data between the terminal and the base station; and the base station, configured to transmit data to the terminal through the relay station, and receive data from the terminal through the relay station.

The relay station of this system extends the function of a conventional relay station which only amplifies and forwards original signal. The relay station of this system can further re-decode and re-encode the original signal, thus being capable of providing data forwarding services for terminals outside of the coverage area of the base station. In addition to a transmitter, a receiver, a duplexer, and an antenna, the relay station further includes: an uplink data processing module, configured to process data transmitted from the terminal to the base station and received by the receiver, and transmit the processed data to the transmitter; a downlink data processing module, configured to process data transmitted from the terminal to the base station and received by the receiver, and transmit the processed data to the transmitter; and a control processor, configured to control the transmitter, the receiver, the uplink data processing module and the downlink data processing module.

In this system, because the relay station is added between the base station and the terminal, the conventional frame structure for data forwarding needs to be changed, and a base station frame structure and a relay station frame structure are applied. The base station frame includes a base station downlink sub-frame and a base station uplink sub-frame. The base station downlink sub-frame includes a downlink terminal sub-frame and a downlink relay sub-frame. The base station uplink sub-frame includes an uplink terminal sub-frame and an uplink relay sub-frame. The relay station frame includes a downlink terminal sub-frame, a downlink relay sub-frame, an uplink terminal sub-frame and an uplink relay sub-frame. Specific frame structures and functions are as the above description.

Moreover, the relay station and the base station orthogonally multiplex the same time-frequency resources. Each relay station manages one or more connections with the base station, and each connection is distinguished by a connection identifier. Connection identifiers are centralized allocated by the base station, and the corresponding relationship between the connection identifiers and their occupied time-frequency resources is broadcasted to terminals within the coverage area of the base station. The terminals extract data from corresponding time-frequency resources.

Those skilled in the art would appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Though illustration and description of the present disclosure have been given with reference to preferred embodiments thereof, it should be appreciated by persons of ordinary skill in the art that various changes in forms and details can be made without deviation from the spirit and scope of this disclosure, which are defined by the appended claims.

What is claimed is:

1. A method for implementing mobile communication, comprising deploying a relay station between a base station and a terminal, and setting a base station frame structure and a relay station frame structure, and the method further comprising:
enabling, by the relay station, relay function after accessing a network; and
forwarding, by the relay station, data between the terminal and the base station according to the base station frame structure and the relay station frame structure.

2. The method according to claim 1, wherein setting the base station frame structure and the relay station frame structure comprises:
setting the base station frame comprises setting a base station downlink sub-frame and a base station uplink sub-frame, wherein the base station downlink sub-frame comprises a downlink terminal sub-frame and a downlink relay sub-frame, and the base station uplink sub-frame comprises an uplink terminal sub-frame and an uplink relay sub-frame; and
setting the relay station frame comprises setting a downlink terminal sub-frame, a downlink relay sub-frame, an uplink terminal sub-frame, and an uplink relay sub-frame.

3. The method according to claim 2, wherein the uplink terminal sub-frame in the base station uplink sub-frame temporally locates before or after the uplink relay sub-frame.

4. The method according to claim 2, wherein the frame header of the downlink relay sub-frame in the base station downlink sub-frame comprises a preamble sequence for the synchronization between the relay station and the base station; or
the frame header of the downlink relay sub-frame in the base station downlink sub-frame does not comprise a preamble sequence.

5. The method according to claim 2, wherein the downlink relay sub-frame occupies all or part of frequency bands.

6. The method according to claim 2, wherein for different transmit sides, traffic bursts in the downlink terminal sub-frame are temporally staggered.

7. The method according to claim 2, wherein the base station downlink sub-frame is temporally divided into two intervals for transmitting data to the relay station which transmits a frame header and the relay station which does not transmit a frame header, respectively.

8. The method according to claim 1, wherein the relay station and the base station orthogonally multiplex the same time-frequency resources, and each relay station manages one or more connections, and each connection is distinguished by a connection identifier.

9. The method according to claim 8, wherein the one connection is managed by one or more relay stations, and each relay station maintains a connection identifier binding table for connections managed by the relay station and forwards data corresponding to the connections managed by the relay station, according to the maintained connection identifier binding table.

10. The method according to claim 1, wherein enabling relay function by the relay station comprises:
accessing, by the relay station, the network, and operating as a terminal, wherein the same frame structure as that of the terminal is applied;
requesting, by the relay station, to enable the relay function to the base station; and
determining, by the relay station, whether the request is approved by the base station, and
if the request is approved by the base station, returning a response to the base station and enabling the relay function, or
if the request is not approved by the base station, accessing the network by the relay station operating as a terminal, wherein the same frame structure as that of the terminal is applied.

11. The method according to claim 1, wherein forwarding data by the relay station between the terminal and the base station according to the base station frame structure and the relay station frame structure comprises:
receiving, by a receiver of the relay station, data from the base station through a downlink relay sub-frame, and decoding the received data to obtain original data comprising control commands transmitted from the base station to the relay station and downlink data transmitted from the base station to the terminals through the relay station;
extracting, by the relay station, the control commands from the obtained original data, and storing, by the relay station, the downlink data comprised in the obtained original data; and
encoding, by the relay station, the downlink data, and transmitting, by a transmitter of the relay station, the encoded downlink data to the terminal in a downlink terminal sub-frame.

12. The method according to claim 1, wherein forwarding data by the relay station between the terminal and the base station according to the base station frame structure and the relay station frame structure comprises:
receiving, by a receiver of the relay station, data from the terminal through an uplink terminal sub-frame, and decoding the received data to obtain original data comprising uplink data transmitted from the terminal to the base station;
storing, by the relay station, the uplink data comprised in the obtained original data; and
encoding, by the relay station, the uplink data, and transmitting, by a transmitter of the relay station, the encoded uplink data to the base station in an uplink delay sub-frame.

13. An apparatus for implementing mobile communication, comprising a transmitter, a receiver, a duplexer, and an antenna, wherein the duplexer is connected with the antenna, and the transmitter and the receiver are connected with the duplexer, and wherein the apparatus further comprises:
an uplink data processing module, configured to process data transmitted from a terminal to a base station and received by the receiver, and transmit the processed data to the transmitter;
a downlink data processing module, configured to process data transmitted from the base station to the terminal and received by the receiver, and transmit the processed data to the transmitter, wherein the downlink data processing module shares the transmitter and the receiver with the uplink data processing module in a time-division manner; and
a control processor, configured to control the transmitter, the receiver, the uplink data processing module and the downlink data processing module.

14. The apparatus according to claim 13, wherein the uplink data processing module further comprises:
an uplink decoding unit, configured to, under the control of the control processor, obtain un-encoded original information data through demodulating, de-symbol mapping, de-interleaving and channel decoding a baseband signal transmitted from the terminal to the base station;
an uplink data buffering unit, configured to buffer the original information data transmitted from the terminal and processed by the uplink decoding unit;
an uplink quality measuring unit, configured to, under the control of the control processor, measure the signal quality of the original information data transmitted from the terminal and processed by the uplink decoding unit; and
an uplink encoding unit, configured to, under the control of the control processor, channel encode, interleave, symbol map and modulate the original information data in the uplink data buffering unit.

15. The apparatus according to claim 13, wherein the downlink data processing module further comprises:
a downlink decoding unit, configured to, under the control of the control processor, obtain un-encoded original information data through demodulating, de-symbol-mapping, de-interleaving and channel decoding a baseband signal transmitted from the base station to the terminal;
a downlink data buffering unit, configured to buffer the original information data processed by the downlink decoding unit;
a base station command extracting unit, configured to extract base station commands from the original information data processed by the downlink decoding unit, and transmit the commands to the control processor; and
a downlink encoding unit, configured to, under the control of the control processor, channel encode, interleave, symbol map and modulate the original information data in the downlink data buffering unit.

16. A system for implementing mobile communication, comprising:
a terminal, configured to transmit data to a base station through a relay station, and receive data from the base station through the relay station;
the relay station, configured to forward data between the terminal and the base station; and
the base station, configured to transmit data to the terminal through the relay station, and receive data from the terminal through the relay station.

17. The system according to claim 16, wherein the relay station comprises a transmitter, a receiver, a duplexer, and an antenna, and the relay station further comprises an uplink data processing module, a downlink data processing module and a control processor.

18. The system according to claim 16, wherein the base station transmits data in a base station frame structure to the relay station, and the relay station transmits data in a relay station frame structure to the base station and the terminal.

19. The system according to claim 16, wherein the relay station and the base station orthogonally multiplex the same time-frequency resources, and one relay station manages one or more connections each of which is distinguished by a connection identifier.
